(19) United States
(12) Patent Application Publication
(10) Pub. No.: US 2010/0308506 A1
(43) Pub. Date: Dec. 9, 2010

(54) Form Release Composition and Method

(75) Inventors: Edward Jarrah, Allentown, PA (US); Min Ma Wang, Macungie, PA (US); Ibrahim Turhan, Orefield, PA (US); Peter John Astrauskas, Mesa, AZ (US)

Correspondence Address: THOMPSON HINE L.L.P.;Intellectual Property Group, P.O. BOX 8801, DAYTON, OH, 45401-8801, US

(73) Assignee: DAYTON SUPERIOR CORPORATION, Miamisburg, OH (US)

(21) Appl. No.: 12/792,103

(22) Filed: Jun. 2, 2010

Related U.S. Application Data
(60) Provisional application No. 61/184,071, filed on Jun. 4, 2009.

(51) Int. Cl. B28B 7/38; B28B 7/36

(52) U.S. Cl. 264/338; 106/38.24

(57) ABSTRACT

A form release composition including a plant oil, an emulsifying agent and water, wherein the plant oil, the emulsifying agent and the water are blended to form an emulsion.

### PRIORITY

This application claims priority from U.S. Ser. No. 61/184,071 filed on Jun. 4, 2009, the entire contents of which are incorporated herein by reference.

### FIELD

This application relates to form release compositions and, more particularly, to compositions and methods for improving the release of a concrete body from a mold using a plant oil in water emulsion.

### BACKGROUND

Molds or forms are commonly used to contain and shape concrete. Specifically, concrete is commonly poured into a form, allowed to set, and then the form is removed, leaving the concrete with a desired shape or configuration.

Form release compositions are commonly applied to the surfaces of forms that will be in contact with concrete, thereby simplifying the removal of the form from the set concrete. While there are no known standards for form release compositions, common requirements include low or no staining, low viscosity for ease of application and removal of the form, minimal residue after the form has been removed, as well as the desire for a smooth concrete surface with no dust.

In terms of product composition, most common form release compositions can be categorized as (1) varying blends of petroleum oils/diesel/fatty acids; (2) water emulsions that are typically petroleum based materials that have been emulsified in water; (3) non-reactive coatings such as waxes, rosins, silicones, soaps or synthetic resins in volatile solvents; (4) waxes; and (5) soaps. However, health and environmental risks associated with using high quantities of mineral oil based materials and volatile solvents are well known. Even in emulsified form in water, mineral oils and petroleum based waxes present health risks and increase dependence on non-renewable resources such as crude oil that is not earth friendly. In addition to health risks, volatile organic solvents also impact the environment due to photochemical reactions with oxides of nitrogen in the atmosphere, thereby forming ground level ozone (a primary component of smog).

Accordingly, those skilled in the art continue to seek effective and commercially viable form release compositions, as well as form release compositions that reduce or eliminate health and environmental risks.

### SUMMARY

In one aspect, the disclosed form release composition may include a plant oil, an emulsifying agent and water, wherein the plant oil, the emulsifying agent and the water are blended to form an emulsion.

In another aspect, the disclosed form release composition may include a plant oil, an emulsifying agent and water, wherein the plant oil, the emulsifying agent and the water are blended to form an emulsion, and wherein the plant oil comprises at most about 10 percent by weight of the composition.

In yet another aspect, the disclosed method for forming concrete may include the steps of preparing a form release composition by forming an emulsion including a plant oil, an emulsifying agent and water, applying the form release composition to at least one surface of a concrete form and, after the applying step, filing the concrete form with concrete.

Other aspects of the disclosed form release composition and method will become apparent from the following description, the accompanying drawings and the appended claims.

### BRIEF DESCRIPTION OF THE DRAWINGS

FIGS. 1A and 1B are photographs of a concrete form released from a cast concrete block, specifically a mini-precast deposit box;

FIG. 2A is a photograph of a textured form liner with a Fractured Fin pattern; and

FIG. 2B is a photograph of a textured form liner with an Ashler Stone pattern.

### DETAILED DESCRIPTION

The disclosed form release composition may be a stable emulsion comprised of raw materials based on renewable resources, may include low or no volatile organic compounds (“VOCs”) and may provide the desired form release function. In one aspect, the disclosed form release composition may include a plant oil, water and an emulsifying agent. Of course, additional components, such as preservatives (e.g., in-can preservatives), anti-foaming agents and rheology modifiers, may be included without departing from the scope of the present disclosure.

The plant oil may be any plant oil, such as a vegetable oil, a tree nut oil or the like. Also, the plant oil may be a mixture of plant oils. In one example, the plant oil may be soybean oil, such as refined soybean oil. In another example, the plant oil may be sunflower seed oil. In yet another example, the plant oil may be peanut oil.

In one aspect, the plant oil may comprise about 1 to about 50 percent by weight of the form release composition. In another aspect, the plant oil may comprise about 1 to about 25 percent by weight of the form release composition. In yet another aspect, the plant oil may comprise about 1 to about 10 percent by weight of the form release composition. In yet another aspect, the plant oil may comprise about 5 to about 10 percent by weight of the form release composition.

The emulsifying agent may be an agent capable of emulsifying the plant oil and the water in the disclosed form release composition. In one aspect, the emulsifying agent may be obtained in-situ by a saponification reaction of an amine, ammonia, ammonium hydroxide or a metallic hydroxide with a fatty acid. Examples of useful amines include monoethanolamine, 2-amino-2-methyl-1-propanol and morpholine. Examples of useful metallic hydroxides include potassium hydroxide and sodium hydroxide. Examples of useful fatty acids include tall oil fatty acid, oleic acid, stearic acid and palmitic acid. Commercially available examples of useful fatty acids include SYLFAT FA-1, available from Arizona Chemical of Jacksonville, Fla., and MWV L-5, available from MeadWestvaco Corporation of Glen Allen, Va.

In one aspect, the emulsifying agent may be used at a concentration of about 5 to about 25 percent by weight based upon the weight of the plant oil in the form release composition. In another aspect, the emulsifying agent may comprise about 1 to about 5 of the form release composition. Those skilled in the art will appreciate that the amount of emulsifying agent used with depend on the type of plant oil used, as well as the type of emulsifying agent used.

Water may comprise the balance of the disclosed form release composition. In one aspect, water may comprise about 50 to about 98 percent by weight of the form release composition. In another aspect, water may comprise about 75 to about 98 percent by weight of the form release composition. In yet another aspect, water may comprise about 85 to about 95 percent by weight of the form release composition.

One or more preservatives (e.g., in-can preservatives) may be present in the disclosed form release composition. The preservative may comprise about 0.10 to about 1.0 percent by weight of the form release composition. Of course, the amount of preservative used will depend on the type of preservative.

One exemplary in-can preservative includes hexahydro-1,3,5-tris(2-hydroxyethyl)-s-trazine and 1,2-benzisothiazolin-3-one, which is commercially available as PROXEL™ TN from Arch Chemicals, Inc. of Norwalk, Conn. Another exemplary in-can preservative includes 1-(3-chloroallyl)-3,5,7-triaza-1-azoniaadamantane chloride, which is commercially available as DOWICIL 75 from the Dow Chemical Company of Midland, Mich.

One or more anti-foaming agent may be present in the disclosed form release composition. The anti-foaming agent may comprise about 0.05 to about 2.0 percent by weight of the form release composition. Of course, the amount of anti-foaming agent used will depend on the type of preservative.

The anti-foaming agent may include a diol ester-type agent, a siloxane, a silicone, a non-silicone antifoaming/defoaming agent, or combinations thereof. Examples of commercially available anti-foaming agents include Antifoam Emulsions FG-10, DSP or 1510 available from Dow Corning of Midland, Mich., FOAMASTER NXZ, available from Cognis Corporation of Monheim, Germany, and DEE FO PI-12 (Ultra Additives), available from Münzing of Bloomfield, N.J.

Since emulsion stability may be reduced by low solid content. A rheology modifier, such as a natural thickener, may be added to the disclosed form release composition to provide long term stability. The rheology modifier may also provide good adhesion to vertical forms and may prevent running down of the form release composition on the forms.

In one aspect, the rheology modifier may include natural gum, such as xanthan gum, or cellulosic thickeners, such as ethyl-hydroxyethyl-cellulose. Examples of commercially available rheology modifiers include KELZAN S available from CP Kelco of Atlanta, Ga.; xanthan gum available from Jungbunzlauer of Basel, Switzerland; BERMOCOLL E 481 FQ available from Akzo Nobel of Amsterdam, the Netherlands; and NATROSOL 250 HHR available from Ashland Aqualon Functional Ingredients of Covington, Ky.

The rheology modifier may comprise about 0.01 to about 2.0 percent by weight of the form release composition. Of course, the amount of the rheology modifier used will depend on the type of rheology modifier used, as well as the technique (e.g., spray, roller or brush) to be used to apply the form release composition to the form.

The disclosed form release composition may be applied to forms (or form liners) formed from various materials, including plywood, high density plywood, plastic faced plywood, fiberglass, steel, aluminum, polystyrene and polyurethane. In one aspect, a gallon of the disclosed form release composition may coat about 200 to about 1500 ft² of form.

### EXAMPLES

### Example 1

A form release composition may be prepared in accordance with the present disclosure by blending the components shown in Table 1 to achieve an emulsion.

TABLE 1

| Component | Percent by Weight |
|---|---|
| Refined Soybean Oil | 10.00 |
| Tall Oil Fatty Acid | 0.75-1.00 |
| Monoethanolamine | 0.19-0.23 |
| Anti-Foaming Agent | 0.05 |
| Rheology Additive | 0.20 |
| Water | 88.29-94.12 |

### Example 2

A form release composition may be prepared in accordance with the present disclosure by blending the components shown in Table 2 to achieve an emulsion.

TABLE 2

| Component | Percent by Weight |
|---|---|
| Refined Soybean Oil | 5.00 |
| Tall Oil Fatty Acid | 0.50 |
| Monoethanolamine | 0.13 |
| Anti-Foaming Agent | 0.05 |
| Rheology Additive | 0.20 |
| Water | 94.12 |

### Example 3

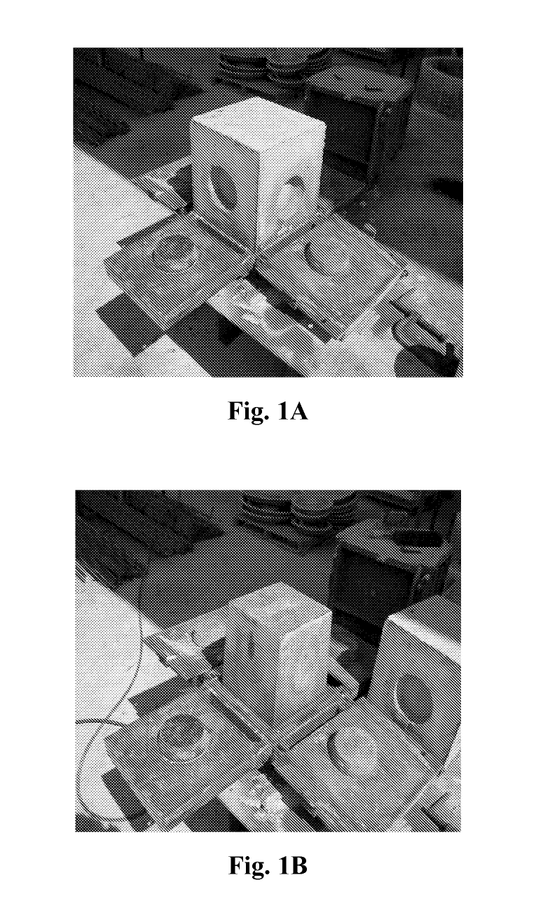

The concrete form shown in FIGS. 1A and 1B defines an inner box with dimensions of 27.9 cm by 25.4 cm by 25.4 cm, thereby providing a surface area of about 3484 cm² (including the top surface). The dimensions of the outer panels of the concrete form are 33.0 cm by 33.0 cm. Each outer panel includes a conical insert at the center with a diameter of 13.3 cm. Therefore, the total surface area of the precast box that receives a form release composition is 8048 cm², including the outer bands of the four conical inserts.

The surfaces of the concrete form were coated with the form release compositions of Examples 1 and 2 using a spray process. About 35 grams of each form release composition was used. Then, the form was filled with concrete. (36.3 kg of Quikrete Concrete Mix mixed with 3.0 liters of water using a concrete drum mixer.) The concrete was consolidated for 10 minutes and then left to cure for 24 hours.

After 24 hours, the side panels of the concrete form were opened and air pressure was applied to the inner box to remove the concrete precast element that was just produced. Observations for ease of cleaning and removal (“1” being the easiest and “10” being the most difficult), amount of air pressure (pounds per square inch) required to remove the precast element and residue left over the mold and over the concrete were noted (“0” being none, “5” being moderate and “10” being the most). The process was repeated three times without cleaning the precast mold to observe concrete residue build up after multiple applications. The results are provided in Table 3 below:

TABLE 3

| | | | | | | | |
|---|---|---|---|---|---|---|---|
| | Ease of | Removal | Residue | Residue | Residue | | |
| | Removal | of Inner | on the | on the | on the | Residue | Cleaning |
| Product Applied: | (Side | Box | Side | Inner | Plastic | on | of Steel |
| 35 grams (23 m²/L) | Panels) | (psi) | Panels | Box | Cups | Concrete | Box |

1st Application

| | | | | | | | |
|---|---|---|---|---|---|---|---|
| Universal Form Oil | 1 | 25 | 3 | 3 | 3 | 3 | 1 |
| Emulsion per Example 2 | 2 | <30 | 1 | 1 | 2 | 1 | 2 |
| Emulsion per Example 1 | 2 | <20 | <2 | 1 | 1 | 1 | 2 |

2nd Application (without cleaning from the 1st application)

| | | | | | | | |
|---|---|---|---|---|---|---|---|
| Emulsion per Example 2 | 2 | <40 | <2 | 1 | 3 | 1 | 3 |
| Emulsion per Example 1 | 2 | <30 | 2 | 2 | 2 | 1 | 2 |

3rd Application (without cleaning from the 1st and 2nd applications)

| | | | | | | | |
|---|---|---|---|---|---|---|---|
| Emulsion per Example 1 | 2 | <35 | 3 | 2 | 2 | 1 | 2 |

### Example 4

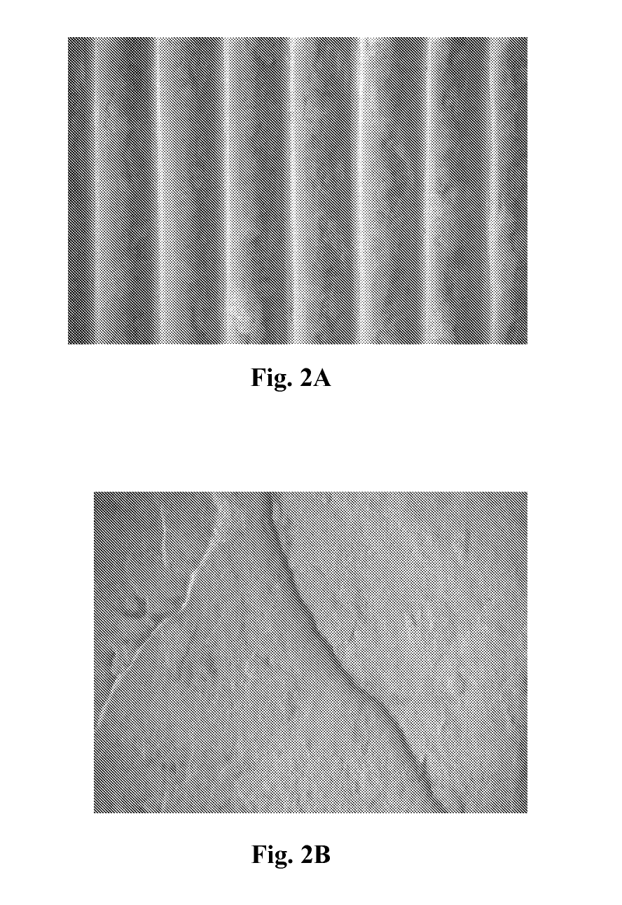

Textured form liners with Fractured Fin (FIG. 2A) or Ashler Stone patterns (FIG. 2B) were obtained from Symons Corporation of Elk Grove, Ill. Depending on the type of resin used, these form liners are classified as SPS (Syndiotactic Polystyrene) Plastic, ABS (Acrylonitrile Butadiene Styrene) Plastic and Elasto-Tex (Polyurethane). The form release compositions of Examples 1 and 2 were spray applied to form liners cut at 30.5 cm by 30.5 cm. The coating was evened out using a soft brush. After 2 hours of drying, the form liners were vertically placed into a cardboard box with the two coated sides facing each. The uncoated sides were up against the cardboard. The test box was then filled with a concrete mix prepared by extending Pavepatch repair mortar produced by Dayton Superior Corporation, with All Purpose Pea Gravel purchased from the Home Depot at a ratio of 11.35 kg pea gravel per 22.7 kg bag of Pavepatch. Following manufacturer's instructions, Pavepatch extended with pea gravel was mixed with 3.0 liter of water using a concrete drum mixer. The concrete mix was placed in the precast form and was consolidated for 10 minutes and then was left to cure for 24 hours. After 24 hours, the four corners of the cardboard box were cut and the form liners were released. Concrete residue left on the forms was recorded, with “0” indicating none, “5” being moderate and “10” being the most. The results are provided in Table 4 below:

TABLE 4

| | SPS | ABS | Elasto- | Elasto- |
|---|---|---|---|---|
| | Plastic ™ | Plastic | Tex ® | Tex ® |
| Product Applied (3.77 | (Fractured | (Fracture | (Fractured | (Ashler |
| grams (24.4 m2/L)) | Fin) | Fin) | Fin) | Stone) |
| Emulsion of Example 2 | 4 | 2 | 1 | 1 |
| Emulsion of Example 1 | <1 | 2 | 1 | 1 |

### Example 5

The form release compositions of Examples 1 and 2 were brush applied over three 17.8 cm diameter steel pans at three application rates: heavy, medium and light. The coated pans were filled with mortar prepared per ASTM C 156. After leveling the surface of the mortar with a wooden trowel, the mortar in the pans was left to cure for 24 hours. After 24 hours, the mortars were removed from the pans with light tapping at the back of the pans and observed for residue left on the pan (“0” indicating none, “5” being moderate and “10” being the most). The results are provided in Table 5 below:

TABLE 5

| | Residue on the 7″ |
|---|---|
| Product | Steel Pans |
| Emulsion per Example 1 | 1 |
| (Heavy, 12.27 m2/L) | |
| Emulsion per Example 1 | 2 |
| (Medium, 24.50 m2/L) | |
| Emulsion per Example 1 | 3 |
| (Light, 36.80 m2/L) | |
| Emulsion per Example 2 | 4 |
| (Heavy, 12.27 m2/L) | |
| Emulsion per Example 2 | N/A |
| (Medium, 24.50 m2/L) | |
| Emulsion per Example 2 | 5 |
| (Light, 36.80 m2/L) | |

Accordingly, those skilled in the art will appreciate that the disclosed form release compositions provide desirable concrete release properties without the health and environmental disadvantages associated with existing solutions. In particular, those skilled in the art will appreciate that the disclosed form release compositions provide desirable concrete release properties using relatively low quantities (e.g., at most about 10 percent by weight) of a plant oil.

Although various aspects of the disclosed form release composition and method have been shown and described, modifications may occur to those skilled in the art upon reading the specification. The present application includes such modifications and is limited only by the scope of the claims.

What is claimed is:

1. A form release composition comprising a plant oil, an emulsifying agent and water, wherein the plant oil, the emulsifying agent and the water are blended to form an emulsion.

2. The form release composition of claim 1 wherein the plant oil comprises at most about 10 percent by weight of the emulsion.

3. The form release composition of claim 1 wherein the plant oil comprises about 1 to about 25 percent by weight of the emulsion.

4. The form release composition of claim 1 wherein the plant oil comprises about 1 to about 10 percent by weight of the emulsion.

5. The form release composition of claim 1 wherein the plant oil comprises about 5 to about 10 percent by weight of the emulsion.

6. The form release composition of claim 1 wherein the plant oil include soybean oil.

7. The form release composition of claim 1 wherein the emulsifying agent is formed in-situ by a saponification reaction between a fatty acid and at least one of an amine, ammonia, ammonium hydroxide and a metallic hydroxide.

8. The form release composition of claim 1 wherein the emulsifying agent comprises about 1 to about 5 percent by weight of the emulsion.

9. The form release composition of claim 1 wherein an amount of the emulsifying agent in the emulsion is about 5 to about 25 percent by weight of an amount of the plant oil in the emulsion.

10. The form release composition of claim 1 wherein the water comprises about 50 to about 98 percent of the emulsion.

11. The form release composition of claim 1 wherein the water comprises about 75 to about 98 percent of the emulsion.

12. The form release composition of claim 1 wherein the water comprises about 85 to about 95 percent of the emulsion.

13. The form release composition of claim 1 further comprising at least one of a preservative, an anti-foaming agent and a rheology modifier.

14. A method for forming concrete comprising the steps of:
preparing a form release composition by forming an emulsion including a plant oil, an emulsifying agent and water;
applying the form release composition to at least one surface of a concrete form; and
after the applying step, filing the concrete form with concrete.

15. The method of claim 14 wherein the applying step includes applying the form release composition with at least one of a sprayer, a roller and a brush.

16. The method of claim 14 wherein the surface of the concrete form is formed from at least one of plywood, high density plywood, plastic faced plywood, fiberglass, steel and aluminum.

17. The method of claim 14 wherein the surface of the concrete form includes a form liner and the form release composition is applied to the form liner, wherein the form liner is formed from polystyrene or polyurethane.

18. The method of claim 14 wherein the form release composition is applied to surface at a rate of about 1 gallon per 200 ft² of the surface to about 1 gallon per 1500 ft² of the surface.
